(19) United States
(12) Patent Application Publication
(10) Pub. No.: US 2024/0232307 A1
(43) Pub. Date: Jul. 11, 2024

(54) IDENTIFYING WHETHER INTERACTING WITH REAL PERSON OR SOFTWARE ENTITY IN METAVERSE

(71) Applicant: Cisco Technology, Inc., San Jose, CA (US)

(72) Inventors: Pete Rai, Surrey (GB); Joel Abraham Obstfeld, Hertfordshire (GB); Simon Peter James Dyke, Hampshire (GB); James Geoffrey Walker, West Sussex (GB)

(21) Appl. No.: 18/151,242

(22) Filed: Jan. 6, 2023

(51) Int. Cl. G06F 21/32

(52) U.S. Cl. CPC G06F 21/32; G06F 2221/2133

(57) ABSTRACT

Methods that generate a proof-of-life indicator used by a metaverse platform to indicate whether an avatar is being controlled by or is representative of a human user or a software-based entity. In these methods, a plurality of data streams are obtained from a plurality of sensors that are configured to monitor activity of a user that is active within the metaverse environment. The plurality of data streams relate to behavioral and biometric characteristics of the user that is interacting within the metaverse environment. The methods involve determining whether the user is a human user or a software-based entity based on aggregating attribute information extracted from the plurality of data streams, generating a proof-of-life indicator that indicates whether the user is the human user or the software-based entity and a confidence level associated with the proof-of-life indicator, and providing the proof-of-life indicator in the metaverse environment.

### TECHNICAL FIELD

The present disclosure generally relates to virtual environments.

### BACKGROUND

Metaverse is an evolution of the Internet. In metaverse, humans interact “within” or are immersed into a virtual environmental. Virtual environments may support interactions with other human entities and/or software-based entities. Virtual environments enable immersive experiences for their users utilizing techniques such as augmented, mixed, and virtual reality, through a range of human-to-machine interface methods including headsets, microphones and headphones, haptic feedback solutions, etc. Some virtual environments are intended to mimic interactions that would take place in the physical world. Other virtual environments may create interactions within a fantasy world where different laws of physics may apply. By using these technologies, users interact with each other and use a range of services, regardless of geographical location or physical capability. Users and software-based entities are typically represented, in metaverse, using avatars. It can be difficult to know whether an avatar represents a human user or is just a software-based entity.

### BRIEF DESCRIPTION OF THE DRAWINGS

FIG. 1 is a block diagram illustrating a metaverse system which includes an interpreter that determines whether a user is interacting with a human or a software-based entity, according to an example embodiment.

FIG. 2 is a data flow diagram associated with a method of generating a proof-of-life indicator indicative of whether an entity in a metaverse environment is controlled by a human or a software-based entity, according to an example embodiment.

FIG. 3 is a diagram illustrating a virtual meeting space of a metaverse environment in which avatars include proof-of-life indicators with confidence levels, according to an example embodiment.

FIG. 4 is a flowchart of a method for providing a proof-of-life indicator that is indicative of whether an entity in a metaverse environment is controlled by a human or a software-based entity, according to an example embodiment.

FIG. 5 is a hardware block diagram of a computing device that may perform functions associated with any combination of operations in connection with the techniques depicted and described in FIGS. 1-4, according to various example embodiments.

### DETAILED DESCRIPTION

### Overview

Techniques are presented herein to generate a proof-of-life indicator based on signals obtained from a plurality of sensors that immerse a user in a metaverse environment. The proof-of-life indicator is used by a metaverse platform to indicate whether an avatar is being controlled by or is representative of a human user or a software-based entity depending on a use-case and context of a virtual environment.

In one form, the method involves obtaining a plurality of data streams from a plurality of sensors that are configured to monitor activity of a user that is active within in a metaverse environment. The plurality of data streams relate to behavioral and biometric characteristics of the user that is interacting within the metaverse environment. The method further involves determining whether the user is a human user or a software-based entity based on aggregating attribute information extracted from the plurality of data streams and generates a proof-of-life indicator that indicates whether the user is the human user or the software-based entity and a confidence level associated with the proof-of-life indicator. The method further involves providing the proof-of-life indicator in the metaverse environment.

### Example Embodiments

A metaverse environment is a computer-generated and visually rendered environment in which entities are represented with avatars. An avatar may be textual (e.g., username), a two-dimensional graphical representation, a three-dimensional graphical representation, or any other perceivable representation of an entity in the metaverse environment. In this computer-generated environment, entities include human users and software-based entities. Software-based entities are sometimes called a “non-player character” (NPC) and are computer driven characters (e.g., CPUs, bots, etc.). While some NPCs may have a limited set of interactions and capabilities, others may be capable of complex interactions and therefore may appear and act like a human user. Thus, it may be difficult to determine whether an avatar represents a human user or a software-based entity. The issue of the human-driven representation versus a software-driven entity can create a series of challenges in virtualized environments including security and confidentiality issues. Further, bad actors may generate computer driven avatars, which are deliberately designed to fool other users that they are representations of an actual human.

The techniques presented herein provide a proof-of-life indicator (“PoLi”). The PoLi is securely used by a metaverse platform to generate a “real person” indicator presented alongside the user's avatar (for example) in a variety of ways appropriate to the use-case or context. The PoLi indicates whether the avatar represents a real person (a human user) or a software-based entity. The PoLi further includes a confidence level (numeric value, a range value, or a percentage) indicating probability or confidence of the determination/classification. The indicator is present to give confidence to human users as to the origin and motivations of other users.

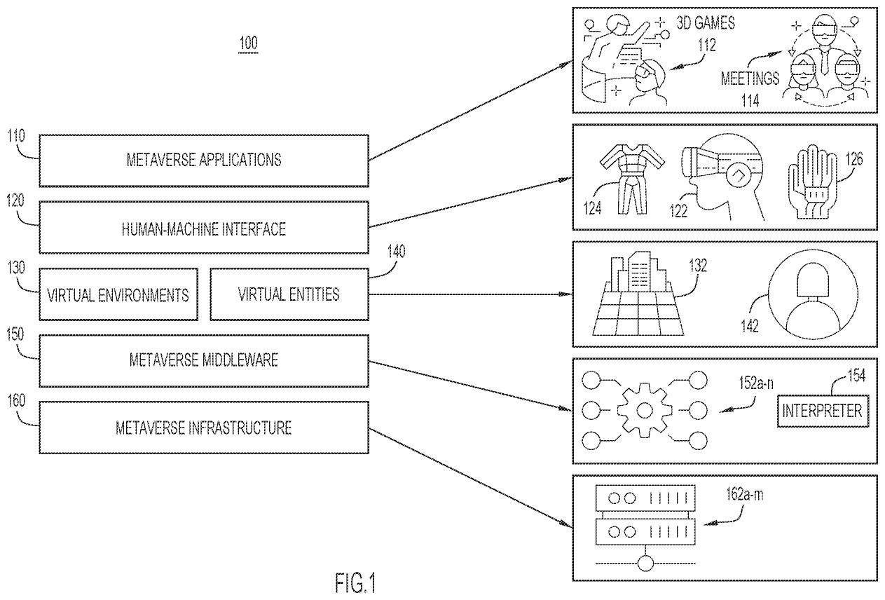

FIG. 1 is a block diagram illustrating a metaverse system 100 which includes an interpreter that determines whether a user is interacting with a human or a software-based entity, according to an example embodiment. The metaverse system 100 includes metaverse applications 110, a human-machine interface 120, virtual environments 130, virtual entities 140, metaverse middleware 150, and a metaverse infrastructure 160.

In the metaverse system 100, the metaverse applications 110 are client applications that immerse one or more users into various digital or virtual spaces. Digital or virtual spaces represent a physical world and/or fantasy worlds. Using the metaverse applications 110, users feel as if they are inside a virtual space as opposed to the actual physical world. By way of an example and not by way of a limitation, the metaverse applications 110 may provide 3D games 112 (single or multi-player), online virtual meetings 114 (social or work collaboration spaces), sports, exercises, and/or shopping. There are many different types of metaverse applications 110. Further, metaverse applications 110 provide different user experiences.

For example, the online virtual meetings 114 may immerse a user into a virtual bar space where user's avatar performs human actions and interacts with other avatars in the virtual bar space. The online virtual meetings 114 may immerse a user into an office building where a user (using an avatar) enters a conference room space and initiates an online collaboration session with other coworkers (represented by avatars). The 3D games 112 may immerse a user into a fantasy world where user's avatar may look like a unicorn, fly like a bird, swim like a fish, barks like a dog, etc. Metaverse applications 110 may provide training environments such as a surgery room space where the user (using his avatar) performs a surgery on a patient represented by another avatar (e.g., a software-based entity).

The users interact in the virtual environments provided by the metaverse applications 110 using the human-machine interface 120. The human-machine interface 120 may also vary widely depending at least on use case scenarios. The human-machine interface 120 includes various user devices (endpoint devices) that allows users to interact with the virtual environments and renders the virtual environments for the users as instructed by the metaverse applications 110 that define input/output for their respective virtual environment.

The human-machine interface 120 is configured to monitor activity in a metaverse environment and may include specialized user devices such as surgical instruments and/or training equipment with various built-in sensors to detect user interactions/motion. Typically, however, the human-machine interface 120 includes user devices such as a sensory immersive headset 122, a haptic body suit 124, haptic gloves 126, directional motion simulations, handheld controllers, a keyboard, a touch screen, goggles, a personal computer, and/or etc. These user devices include sensors to detect user's motion and/or interactions. The user devices also include one or more visual displays to immerse the user into the metaverse environment. Additionally, the human-machine interface 120 may include user devices such as a microphone, speakers, haptic devices, olfactory devices, etc.

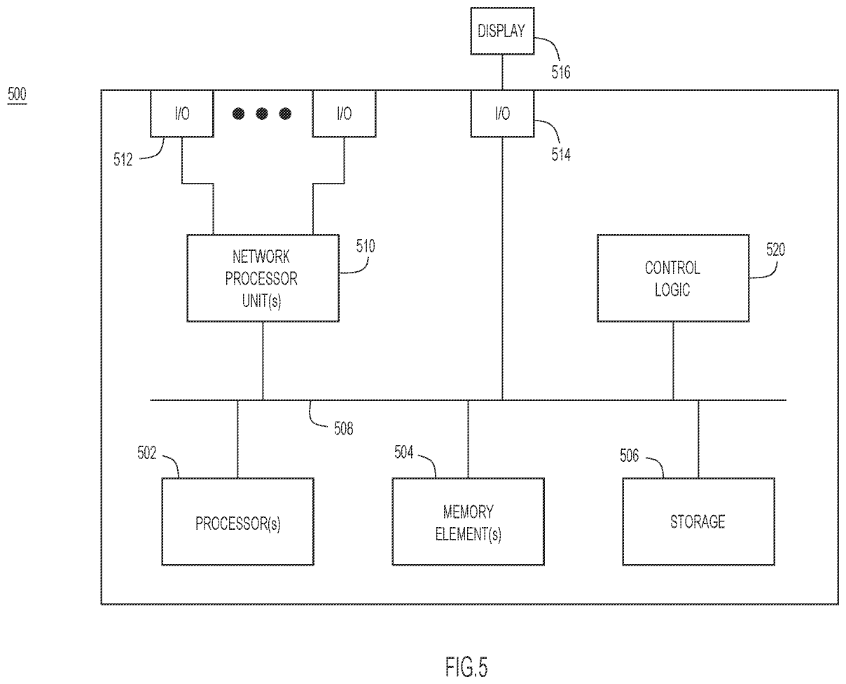

In various example embodiments, user devices may each include a network interface, at least one processor, and a memory. Each user device may be an apparatus or any programmable electronic or computing device capable of executing computer readable program instructions. The network interface may include one or more network interface cards (having one or more ports) that enable components of the entity to send and receive packets or data over network(s) such as a local area network (LAN) or a wide area network (WAN), and/or wireless access networks. Each user device may include internal and external hardware components such as those depicted and described in further detail in FIG. 5. In one example, at least some of these user devices may be embodied as virtual devices with functionality distributed over a number of hardware devices, such as servers, etc. For example, some of the computational workload may be performed in a cloud.

As noted above, metaverse applications 110 immerse users into virtual environments 130 that vary widely. For example, a virtual environment may be a virtual city space 132 that mimics a real-world city with buildings, streets, shops, etc. As another example, a virtual environment may be an office with conference or meeting rooms in which a table, chairs, a phone, a whiteboard, etc. are provided for the users to interact using their avatars. Virtual environments 130 are visually rendered environments that have various characteristics or attributes. Attributes of the virtual environments 130 may be defined based on physics engine, geospatial positions and interaction, art direction, audio design, haptic design, textures, etc. The virtual environments 130 may depict therein virtual entities 140 such as the avatar 142. The avatar 142 represents a human user or a software-based entity. The avatar 142 may also include various attributes such as skins, accessories, and capabilities (fly, run, etc.). While only the avatar 142 is shown, it is understood that users may have a plurality of avatars. The virtual environments 130 defined by the metaverse applications and virtual entities 140 are rendered using metaverse middleware 150.

In the metaverse system 100, the metaverse middleware 150 provides basic functions 152a-n and an interpreter 154 that are loaded onto an operating system (OS). The notations 1, 2, 3, . . . n; a, b, c, . . . n; “a-n”, and the like illustrate that the number of elements can vary depending on a particular implementation and is not limited to the number of elements being depicted or described. Moreover, the basic functions 152a-n may vary in number and types based on a particular deployment and use case scenario.

The basic functions 152a-n include processing engines, analytics, trackers, and/or detectors, for rendering and interacting in the virtual environments 130. The processing engines include a three-dimensional (3D) engine for rendering virtual environments 130 in 3D (360 degrees view), physics engines that define interactions in the virtual environments 130, and audio engines that process detected audio stream and/or render sounds and/or utterances in the virtual environments 130. Trackers track the state of a virtual environment (running, loaded, etc.), state and location of avatars (e.g., at a particular location within the virtual environment), etc. The tracking information may be shared in the metaverse environment. Detectors detect collisions among avatars or objects, conflicts in rendering various objects, etc. The metaverse middleware 150 may further include financial services, advertising services, e-stores (for avatars, skins, accessories, etc.), design tools and frameworks. In one example embodiment, the metaverse middleware 150 includes a standard library of basic functions (not specific to metaverse) and the metaverse-related functions are defined by a respective metaverse application.

According to one or more example embodiments, the interpreter 154 receives signals or indicators from the human-machine interface 120 and probabilistically determines whether an entity in a metaverse environment is controlled by a human or a software-based entity. The interpreter 154 generates a proof-of-life indicator (PoLi) and computes a confidence level associated with the PoLi, as further described below.

In the metaverse system 100, the metaverse infrastructure 160 may include various hardware and software components 162a-m. Specifically, the metaverse infrastructure 160 includes appropriate hardware (e.g., processor(s), memory element(s), antennas and/or antenna arrays, baseband processors (modems), and/or the like such as those depicted and described in further detail in FIG. 5), software, logic, and/or the like to facilitate rendering metaverse environment and executing metaverse applications 110. For example, the metaverse infrastructure 160 includes compute resources (memories, CPUs, etc.), network and telecommunications (network interfaces, antennas, etc.), bandwidth, processing capacity, hosting, geolocation tracking/blocking (sensors), access and security related components (firewall, etc.), graphics processing units (GPUs), etc.

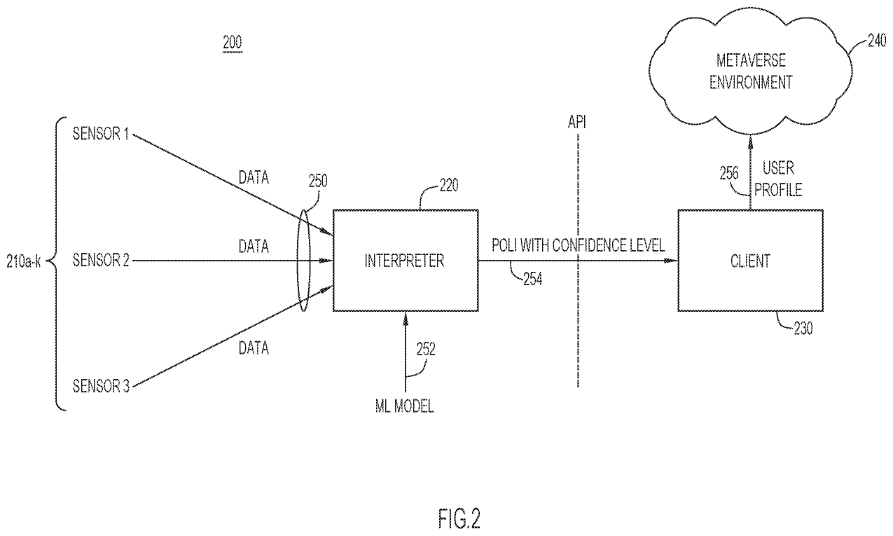

With continued reference to FIG. 1, FIG. 2 is a sequence diagram illustrating a method 200 of generating a proof-of-life indicator indicative of whether an entity in a metaverse environment is controlled by a human user or a software-based entity, according to an example embodiment. The method 200 involves a plurality of sensors 210a-k that may be integrated into various user devices of the human-machine interface 120 of FIG. 1 and an interpreter 220 such as the interpreter 154 of FIG. 1. The method 200 further involves a client 230 such as a client platform that immerses a user into a metaverse environment 240 such as the virtual environments 130 of FIG. 1.

The plurality of sensors 210a-k are configured to monitor activity of a user that is active within a metaverse environment and detect biometric signals and behavioral characteristics of the user at the client 230. The plurality of sensors 210a-k include biometric monitors or sensors that monitor biometrics and vital signs. For example, the biometric sensors are incorporated into a suitably enabled user device e.g., head-mounted display, hand-held controllers etc. In one example embodiment, the biometric sensors include one or more of: skin temperature sensors, retinal scanners, photoplethysmography (using green LEDs and pairing them with photodiodes to detect blood flowing through the skin), fingerprint readers, and/or gait measurements.

These are just some non-limiting examples of the biometric sensors of the plurality of sensors 210a-k. While, in one example embodiment, these biometric sensors are embedded into one or more user devices such as a headset or hand-held controller(s), in another example embodiment, at least some of these biometric sensors may be independent of the user devices (e.g., a heart monitor or another standalone sensor). As human-computer interaction (HCl) devices (such as user devices of the human-machine interface 120 of FIG. 1) evolve, additional sensors may be added and/or existing sensor arrays may further be refined to help enable new metaverse applications and experiences for users and/or developers, and as such, are within the scope of this disclosure.

The plurality of sensors 210a-k are further configured to detect behavioral characteristics of a user that is interacting within the metaverse environment 240. In this case, the plurality of sensors 210a-k include motion sensors such as one or more accelerometers and gyroscopes. In one example embodiment, these motion sensors are integrated into one or more user devices such as the sensory immersive headset 122 of FIG. 1, the haptic gloves 126 of FIG. 1, etc. The motion sensors record behavioral characteristics as device inputs such as user motion data (via a device multi-axis inertial measurement unit (IMU)).

The plurality of sensors 210a-k may also include one or more microphones that detects audio stream such as user speech and utterances. The microphones may be a separate device or integrated into one or more of the user devices such as the sensory immersive headset 122 of FIG. 1.

The interpreter 220 obtains a plurality of data streams from the plurality of sensors 210a-k to probabilistically determine whether a user that is interacting in a metaverse environment is a human user or a software-based entity. The interpreter 220 obtains biometric data from the biometric sensors to determine if the user is a human user (a real person). The interpreter 220 may further compare motion data obtained from motion sensors to typical human behaviors (or even the previously learned behaviors of the specific user) and contribute this information to determine whether the entity (avatar) is controlled by a human user or a software-based entity. The interpreter 220 may further compare audio (such as speech and/or utterances) obtained from the one or more microphones to determine whether the entity is controlled by a human user or a software-based entity. The interpreter 220 profiles motion data and/or audio to determine if the user is a human user i.e., whether an entity in the metaverse environment 240 is controlled by a human entity or software-based entity.

In one example embodiment, multiple biometric and behavioral factors/characteristics are used to determine if the user is human as opposed to determining a hard-to-spoof trusted user identity and/or perform authentication. While in one example embodiment, the interpreter 220 may be configured to classify the user into one or more categories such as adult user, child user, animal, etc., the interpreter 220 is not concerned with user's specific identity or authentication. The behavioral and audio profiling is for a particular category of entities (such as an adult human user, a bot, etc.)

In one example embodiment, the interpreter 220 is at a client side such as at a personal computer or a user device that renders the metaverse environment 240. In another example embodiment, the interpreter 220 may be in a cloud. The interpreter 220 generates a proof-of-life indicator (PoLi) with a respective confidence level and provides the PoLi with the confidence level to the client 230 (e.g., the client platform). In this case, the user device(s) do not convey raw biometrics directly to the client 230 (the client platform) for privacy reasons but provide, to the client 230, the PoLi (generated by the interpreter 220). The client 230 may determine or set requirements for participating user devices about how the PoLi is to be generated from device biometric sensors and user behavior (behavioral and biometric characteristics). The client 230 may share PoLi with its confidence level in the metaverse environment 240 along with the user's avatar in one or more of the metaverse applications 110 of FIG. 1.

Specifically, the method 200 involves at 250, receiving a plurality of data streams from the plurality of sensors 210a-k. For example, when a user is a wearer of a virtual reality or xR-type device (user devices of the human-machine interface 120 of FIG. 1), the xR-type device typically generates data streams from its sensor array (the plurality of sensors 210a-k) when it is powered on and/or in use.

At 252, multiple sensor data streams are brought together (aggregated) within the interpreter 220. The interpreter 220 performs machine learning (ML) to generate aggregated attribute information extracted from the sensor data streams. The interpreter then generates a PoLi and compute its confidence level based on the aggregated attribute information extracted from the sensor data streams. The interpreter 220 has one or more machine learning (ML) models that analyze an aggregated view of the different sensor data stream characteristics, to determine a classification as to whether the sensor data is associated with activity of a real-life human. The interpreter 220 may assign different weights to different sensor data streams based on the ML model. For example, data stream from a biometric skin temperature sensor may have a higher weight than a gyroscope sensor. Further, by introducing more sensors to the ML model, the confidence level in the classification is increased. On the other hand, if the number of activated sensors decreases, the confidence level in the classification may also decrease. The interpreter 220 generates the PoLi using ML and computes the confidence level of the classification.

In one example embodiment, the PoLi conveys two elements of metadata: a string indicating the classification type (e.g., human, software-based entity) and a numerical value indicating the confidence of that classification. For example, the confidence level may be expressed as a percentage (0% being the lowest/no confidence, 100% being the highest/very confident in the determination) or a numeric value within a particular range of values. The PoLi confidence level may be increased or decreased based on a number and type of sensors. The PoLi confidence level may be increased based on the aggregated sensor data readings extracted from the plurality of data streams. Additionally, the PoLi confidence level and even the classification itself may change over time. That is, as an avatar continues to interact within one or more virtual spaces in the metaverse environment, additional data streams are obtained and analyzed, to update the PoLi and the respective confidence level.

At 254, the interpreter 220 generates an event through a northbound interface which expresses the classification of either human or not (PoLi) with the confidence level. The client 230 receives the PoLi with the respective confidence level. In one example embodiment, the updated PoLi and the respective confidence level are provided at a predetermined time interval or based on trigger events such as the user entered the virtual space, started the metaverse application, etc. In another example embodiment, the PoLi and its respective confidence level are continuously updated based on each determination/classification. In yet another example embodiment, to save on computational resources, the updated PoLi and the respective confidence level are communicated only if the change is significant as defined in the respective metaverse application or user settings (e.g., 10 points value or change in the classification).

The client 230 may store the PoLi with its confidence level in a user profile that is stored at the client 230 or in a cloud. At 256, the client 230 provides the user profile to the metaverse environment 240. The user profile includes the PoLi and the confidence level. The user profile may further include a selected avatar, skin, etc. The client 230 provides the PoLi together with other attributes of the user/avatar to a target virtual space in the metaverse environment.

In one example embodiment, the PoLi may be generated on-demand (a pull-based approach). That is, one of the metaverse applications (such as the metaverse applications 110 of FIG. 1) may request a PoLi for a selected target avatar in the virtual space (e.g., based on a user request or at the request of an internal component of the metaverse application). In this case, the interpreter 220 is invoked to generate the PoLi with the confidence level for the selected target avatar by communicating with one or more user device sensors to obtain the plurality of data streams.

For example, the user clicks on the target avatar in a virtual space of the metaverse environment and the interpreter 220 determines whether the target avatar is controlled by a human or a software-based entity. In this case, the metaverse application receives a PoLi message with the PoLi indicator and the respective confidence level. The metaverse application then determines how to act/react to the PoLi message. Specifically, each metaverse application determines how and when to use the PoLi with the confidence level. Presenting and/or using PoLi with its confidence level may vary widely depending on a particular use case scenario, type of the metaverse application, application settings, user settings, etc. Further, each metaverse application may have different thresholds for various confidence levels of the PoLi.

With continued reference to FIGS. 1 and 2, FIG. 3 is a view illustrating a virtual meeting space 300 of a metaverse environment in which avatars include proof-of-life indicators (PoLis) with confidence levels, according to an example embodiment. The virtual meeting space 300 is a 3D meeting space with a conference room 310 and a plurality of avatar meeting participants 312a-j such as a first avatar 312a, a second avatar 312b, and a third avatar 312j. The virtual meeting space 300 further includes a user avatar 320 that is about to enter the conference room 310. The user avatar 320 may be controlled by a host of the virtual meeting session in the conference room 310.

The host (represented by the user avatar 320) may be wearing a virtual reality headset and initiates the metaverse meeting session in the conference room 310. The host has user settings 322 for metaverse meeting sessions (e.g., virtual meetings) such as avatars with PoLi confidence level below 50% are not to be shown and are to be excluded from the conference room 310, with PoLi confidence level above 60% but below 75% are to be ghosted or shaded, and with PoLi confidence level above 75% are to be presented with no change. As such, a participant represented by the third avatar 312j is shaded.

During an ongoing virtual meeting session, the confidence levels may increase or decrease based on user interactions (represented by avatars) within the metaverse environment. For example, the participant represented by the third avatar 312j may speak or interact with other users (avatars) during the virtual meeting session. The interpreter 220 of FIG. 2 may then update the confidence level of the third avatar 312j such that when it is above 75%, the third avatar 312j is no longer ghosted or shaded. As another example, an excluded user (represented by an avatar) that continues to interact within the metaverse environment may increase the PoLi confidence level and may eventually be able to enter the conference room 310. Until the confidence level reaches above the threshold C1, the excluded user is hidden or hiding e.g., the avatar of the user is unable to open the door 314 (e.g., the door 314 is locked) or the avatar's appearance is hidden from being displayed in the virtual space (the avatar is hiding). As yet another example, an avatar that makes a move or a sound that cannot be made if human controlled, may result in decreasing the confidence level of its PoLi.

The virtual meeting space 300 is just an example of presenting the PoLi. Some of metaverse applications 110 may present the PoLi visually, haptically, and/or via audio, based on environmental presentation methods available in the respective metaverse application. That is, an appearance of an avatar may be modified based on the PoLi and/or the respective confidence level by changing one or more attributes of the avatar such as colors, shadings, appearance, etc.

According to one example embodiment, within a visual rendering application, the PoLi may be displayed to other users within the metaverse environment as a symbol such as a “heartbeat” symbol, a pulse, or a similar visual metaphor. Additionally, the symbol may include the confidence level. As an example, the visual indicator may be provided only when a predetermined threshold is reached (e.g., the confidence level is above 90%). As yet another example, a color-coding scheme may be applied to indicate the degree of confidence or confidence level in making the determination such as a grey heart for a bot, a pink heart for a human when the confidence level is above 60% but below 85%, and a red heart for a human when the confidence level is above 85%.

In another example embodiment, the PoLi is not necessarily rendered but rather trigger a particular event, action, or an occurrence by a metaverse application. For example, in the metaverse game application, if a user hits a first avatar controlled by a human user, the first avatar may disappear (e.g., die) whereas if the user hits a second avatar controlled by a software-based entity, the second avatar may remain unchanged or hit back.

In yet another example embodiment, the PoLi may be hidden or hiding in some contexts (such as games) and exposed in others (such as meeting environments). Further, a user may set a preference such that the indicator is always shown (displayed) so that they are always able to determine if an entity is software-based entity or a real person e.g., in a virtual dating bar setting space.

In yet another example embodiment, symbols are generated to indicate software-based entities where there is an absence of PoLi (e.g., a robot icon is displayed above an avatar that represents a software-based entity). Therefore, entities without an indicator are implicitly assumed to represent human users.

As noted above, presentation methods may further be modified based on their defined PoLi thresholds. For example, in an adult application setting, such as a multi-user video game, the metaverse application may determine that if any confidence levels for the PoLi are above 80%, then the metaverse application “trusts” that a target avatar is a human. In one example embodiment, a metaverse application may need to know whether the avatar represents a software-based entity to spawn additional applications or services to interact with the avatar.

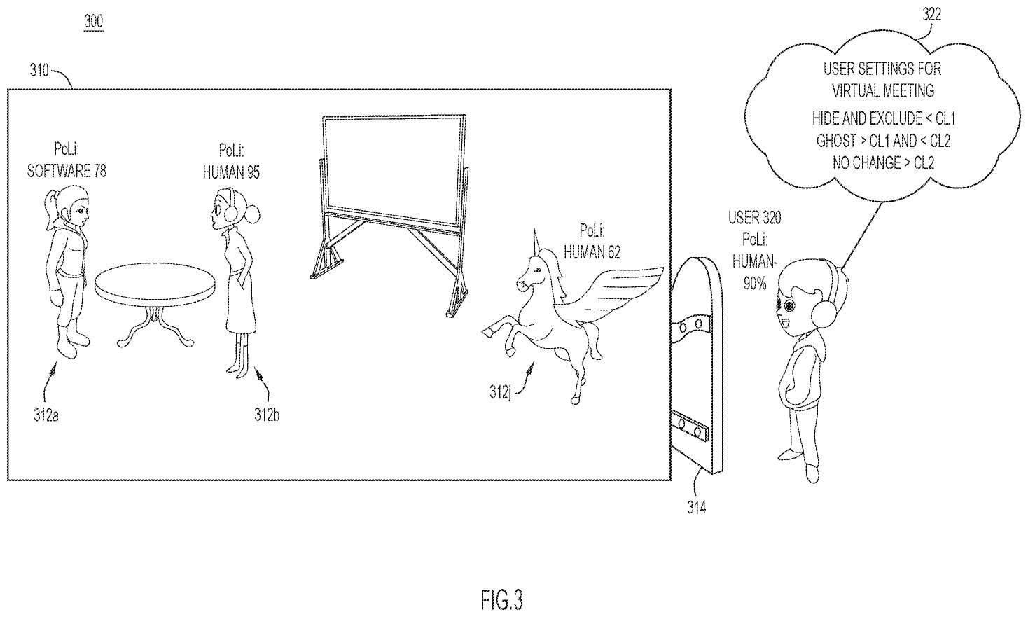

The techniques presented herein allow users to probabilistically determine if entities (anonymous or with an identity) in the metaverse environment represent a human or a software-based entity. The techniques presented herein generate a representative numerical indicator (e.g., a confidence level expressed as a percentage), which a client system can then interpret and use as needed. For example, overlaying a visual indicator on the avatar as shown in FIG. 3 or producing an audio-based indicator to express whether they are dealing with a human or not. This enables the client system to then determine a “threshold” for which to confirm that a human controls the target avatar based on the application use case.

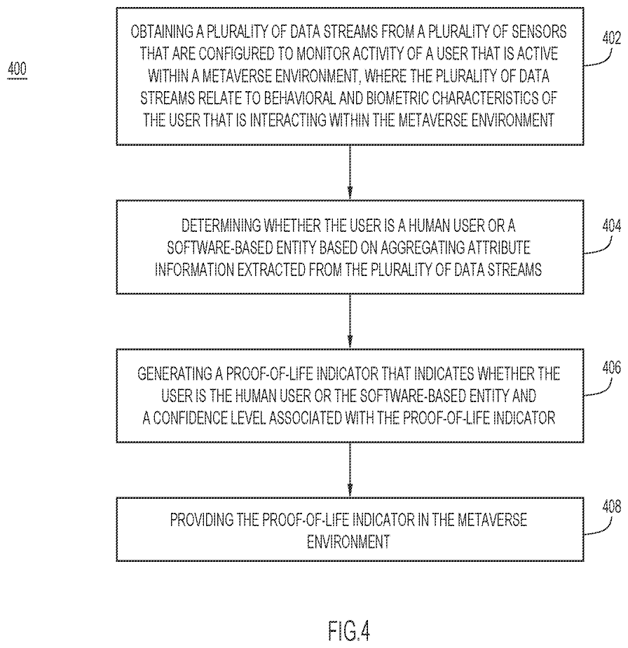

FIG. 4 is a flowchart illustrating a (computer-implemented) method 400 of providing a proof-of-life indicator that is indicative of whether an entity in a metaverse environment is controlled by a human or a software-based entity, according to an example embodiment. The method 400 may be performed by one or more computing devices. For example, the method 400 may be performed by the interpreter 154 of FIG. 1 or the interpreter 220 of FIG. 2.

The method 400 involves at 402, obtaining a plurality of data streams from a plurality of sensors that are configured to monitor activity of a user that is active within a metaverse environment. The plurality of data streams relate to behavioral and biometric characteristics of the user that is interacting within the metaverse environment.

The method 400 further involves at 404, determining whether the user is a human user or a software-based entity based on aggregating attribute information extracted from the plurality of data streams.

The method 400 further involves at 406, generating a proof-of-life indicator that indicates whether the user is the human user or the software-based entity and a confidence level associated with the proof-of-life indicator and at 408, providing the proof-of-life indicator in the metaverse environment.

In one instance, the operation 408 of providing the proof-of-life indicator in the metaverse environment may include configuring each of a plurality of avatars in a virtual space of the metaverse environment based on a respective proof-of-life indicator for each of the plurality of avatars.

According to one or more example embodiments, the operation of configuring each of the plurality of avatars in the virtual space may include at least one of hiding, in the virtual space, at least a first avatar of the plurality of avatars that has an associated proof-of-life indicator indicating control by the software-based entity, or modifying an appearance of a respective avatar from the plurality of avatars in the virtual space that has the associated proof-of-life indicator indicating control by the software-based entity.

In one form, the operation of configuring each of the plurality of avatars may include modifying the appearance of the respective avatar from the plurality of avatars by determining an attribute for the respective avatar from a plurality of attributes based on the confidence level of the associated proof-of-life indicator. The plurality of attributes may include different colors, shadings, or appearances for a particular range of values of the confidence level.

According to one or more example embodiments, the operation 404 of determining whether the user is the human user or the software-based entity may include determining, at a client, whether the user is the human user or the software-based entity based on biometric data obtained from one or more biometric sensors of at least one user device and based on profiling motion data obtained from the at least one user device during interactions of the user within the metaverse environment. The operation 404 of determining whether the user is the human user or the software-based entity may further include determining, at the client, whether the user is the human user or the software-based entity based on profiling an audio stream obtained from the at least one user device during the interactions of the user within the metaverse environment.

In one instance, the operation 404 of determining whether the user is the human user or the software-based entity may include increasing or decreasing the confidence level associated with the proof-of-life indicator based on a number and types of the plurality of sensors.

In another instance, the operation 404 of determining whether the user is the human user or the software-based entity may include generating an aggregated user profile by combining the attribute information and determining the confidence level based on the aggregated user profile.

In one form, the operation 408 of providing the proof-of-life indicator may include providing the proof-of-life indicator together with other attributes of the user to a target virtual space in the metaverse environment.

In another form, the method 400 may further involve updating the confidence level associated with the proof-of-life indicator for the user based on user interactions in one or more virtual spaces in the metaverse environment.

FIG. 5 is a hardware block diagram of a computing device 500 that may perform functions associated with any combination of operations in connection with the techniques depicted in FIGS. 1-4, according to various example embodiments, including, but not limited to, operations of one or more user devices such as at least some of the user devices of the human-machine interface 120 of FIG. 1, the interpreter 154 of FIG. 1, or the interpreter 220 of FIG. 2. It should be appreciated that FIG. 5 provides only an illustration of one example embodiment and does not imply any limitations with regard to the environments in which different example embodiments may be implemented. Many modifications to the depicted environment may be made.

In at least one embodiment, computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with one or more memory elements 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, and/or any other I/O port(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 516, a display screen (touch screen on a mobile device), or the like.

In various embodiments, control logic 520 can include instructions that, when executed, cause processor(s) 502 to perform operations, which can include, but not be limited to, providing overall control operations of computing device; interacting with other entities, systems, etc.

described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a communication interface to enable communication with devices operating to provide a metaverse environment and a processor. The processor is configured to perform various operations including obtaining a plurality of data streams from a plurality of sensors that are configured to monitor activity of a user that is active within the metaverse environment. The plurality of data streams relate to behavioral and biometric characteristics of the user that is interacting within the metaverse environment. The operations further include determining whether the user is a human user or a software-based entity based on aggregating attribute information extracted from the plurality of data streams and generating a proof-of-life indicator that indicates whether the user is the human user or the software-based entity and a confidence level associated with the proof-of-life indicator. The operations further include providing the proof-of-life indicator in the metaverse environment.

In yet another example embodiment, one or more non-transitory computer readable storage media encoded with instructions are provided. When the media is executed by a processor, the instructions cause the processor to execute a method that involves obtaining a plurality of data streams from a plurality of sensors that are configured to monitor activity of a user that is active within a metaverse environment. The plurality of data streams relate to behavioral and biometric characteristics of the user that is interacting within the metaverse environment. The method further involves determining whether the user is a human user or a software-based entity based on aggregating attribute information extracted from the plurality of data streams and generating a proof-of-life indicator that indicates whether the user is the human user or the software-based entity and a confidence level associated with the proof-of-life indicator. The method further involves providing the proof-of-life indicator in the metaverse environment.

In yet another example embodiment, a system is provided that includes the devices and operations explained above with reference to FIGS. 1-5.

The programs described herein (e.g., control logic 520) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 506 and/or memory elements(s) 504 can store data, software, code, instructions (e.g., processor instructions), logic, parameters, combinations thereof, and/or the like used for operations described herein. This includes the storage 506 and/or memory elements(s) 504 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)),

Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining a plurality of data streams from a plurality of sensors that are configured to monitor activity of a user that is active within a metaverse environment, wherein the plurality of data streams relate to behavioral and biometric characteristics of the user that is interacting within the metaverse environment;
determining whether the user is a human user or a software-based entity based on aggregating attribute information extracted from the plurality of data streams;
generating a proof-of-life indicator that indicates whether the user is the human user or the software-based entity and a confidence level associated with the proof-of-life indicator; and
providing the proof-of-life indicator in the metaverse environment.

2. The method of claim 1, wherein providing the proof-of-life indicator in the metaverse environment includes:
configuring each of a plurality of avatars in a virtual space of the metaverse environment based on a respective proof-of-life indicator for each of the plurality of avatars.

3. The method of claim 2, wherein configuring each of the plurality of avatars in the virtual space includes at least one of:
hiding, in the virtual space, at least a first avatar of the plurality of avatars that has an associated proof-of-life indicator indicating control by the software-based entity, or
modifying an appearance of a respective avatar from the plurality of avatars in the virtual space that has the associated proof-of-life indicator indicating control by the software-based entity.

4. The method of claim 3, wherein configuring each of the plurality of avatars includes modifying the appearance of the respective avatar from the plurality of avatars by:
determining an attribute for the respective avatar from a plurality of attributes based on the confidence level of the associated proof-of-life indicator, the plurality of attributes including different colors, shadings, or appearances for a particular range of values of the confidence level.

5. The method of claim 1, wherein determining whether the user is the human user or the software-based entity includes:
determining, at a client, whether the user is the human user or the software-based entity based on biometric data obtained from one or more biometric sensors of at least one user device;
determining, at the client, whether the user is the human user or the software-based entity based on profiling motion data obtained from the at least one user device during interactions of the user within the metaverse environment; and
determining, at the client, whether the user is the human user or the software-based entity based on profiling an audio stream obtained from the at least one user device during the interactions of the user within the metaverse environment.

6. The method of claim 1, wherein determining whether the user is the human user or the software-based entity includes:
increasing or decreasing the confidence level associated with the proof-of-life indicator based on a number and types of the plurality of sensors.

7. The method of claim 1, wherein determining whether the user is the human user or the software-based entity includes:
generating an aggregated user profile by combining the attribute information; and
determining the confidence level based on the aggregated user profile.

8. The method of claim 1, wherein providing the proof-of-life indicator includes:
providing the proof-of-life indicator together with other attributes of the user to a target virtual space in the metaverse environment.

9. The method of claim 8, further comprising:
updating the confidence level associated with the proof-of-life indicator for the user based on user interactions in one or more virtual spaces in the metaverse environment.

10. An apparatus comprising:
a communication interface to enable communication with devices operating to provide a metaverse environment; and
a processor to perform operations comprising:
obtaining a plurality of data streams from a plurality of sensors that are configured to monitor activity of a user that is active within the metaverse environment, wherein the plurality of data streams relate to behavioral and biometric characteristics of the user that is interacting within the metaverse environment;
determining whether the user is a human user or a software-based entity based on aggregating attribute information extracted from the plurality of data streams;
generating a proof-of-life indicator that indicates whether the user is the human user or the software-based entity and a confidence level associated with the proof-of-life indicator; and
providing the proof-of-life indicator in the metaverse environment.

11. The apparatus of claim 10, wherein the processor is configured to provide the proof-of-life indicator in the metaverse environment by:
configuring each of a plurality of avatars in a virtual space of the metaverse environment based on a respective proof-of-life indicator for each of the plurality of avatars.

12. The apparatus of claim 11, wherein the processor configures each of the plurality of avatars in the virtual space by performing at least one of:
hiding, in the virtual space, at least a first avatar of the plurality of avatars that has an associated proof-of-life indicator indicating control by the software-based entity, or
modifying an appearance of a respective avatar from the plurality of avatars in the virtual space that has the associated proof-of-life indicator indicating control by the software-based entity.

13. The apparatus of claim 12, wherein the processor configures each of the plurality of avatars by modifying the appearance of the respective avatar from the plurality of avatars, the processor is configured to modify the appearance of the respective avatar from the plurality of avatars by:
determining an attribute for the respective avatar from a plurality of attributes based on the confidence level of the associated proof-of-life indicator, the plurality of attributes including different colors, shadings, or appearances for a particular range of values of the confidence level.

14. The apparatus of claim 10, wherein the processor is configured to determine whether the user is the human user or the software-based entity by:
determining, at a client, whether the user is the human user or the software-based entity based on biometric data obtained from one or more biometric sensors of at least one user device;
determining, at the client, whether the user is the human user or the software-based entity based on profiling motion data obtained from the at least one user device during interactions of the user within the metaverse environment; and
determining, at the client, whether the user is the human user or the software-based entity based on profiling an audio stream obtained from the at least one user device during the interactions of the user within the metaverse environment.

15. The apparatus of claim 10, wherein the processor is configured to determine whether the user is the human user or the software-based entity by:
increasing or decreasing the confidence level associated with the proof-of-life indicator based on a number and types of the plurality of sensors.

16. The apparatus of claim 10, wherein the processor is configured to determine whether the user is the human user or the software-based entity by:
generating an aggregated user profile by combining the attribute information; and
determining the confidence level based on the aggregated user profile.

17. The apparatus of claim 10, wherein the processor is configured to provide a proof-of-life indicator by:
providing the proof-of-life indicator together with other attributes of the user to a target virtual space in the metaverse environment.

18. One or more non-transitory computer readable storage media encoded with software comprising computer executable instructions that, when executed by a processor, cause the processor to perform a method including:
obtaining a plurality of data streams from a plurality of sensors that are configured to monitor activity of a user that is active within a metaverse environment, wherein the plurality of data streams relate to behavioral and biometric characteristics of the user that is interacting within the metaverse environment;
determining whether the user is a human user or a software-based entity based on aggregating attribute information extracted from the plurality of data streams;
generating a proof-of-life indicator that indicates whether the user is the human user or the software-based entity and a confidence level associated with the proof-of-life indicator; and
providing the proof-of-life indicator in the metaverse environment.

19. The one or more non-transitory computer readable storage media according to claim 18, wherein the computer executable instructions cause the processor to provide the proof-of-life indicator in the metaverse environment by:
configuring each of a plurality of avatars in a virtual space of the metaverse environment based on a respective proof-of-life indicator for each of the plurality of avatars.

20. The one or more non-transitory computer readable storage media according to claim 19, wherein the computer executable instructions cause the processor to configure each of the plurality of avatars in the virtual space by performing at least one of:
hiding, in the virtual space, at least a first avatar of the plurality of avatars that has an associated proof-of-life indicator indicating control by the software-based entity, or
modifying an appearance of a respective avatar from the plurality of avatars in the virtual space that has the associated proof-of-life indicator indicating control by the software-based entity.
